(19) United States
(12) Patent Application Publication
(10) Pub. No.: US 2018/0032677 A1
(43) Pub. Date: Feb. 1, 2018

(54) A DATA PROCESSING SYSTEM AND THE RELATED METHOD FOR DISPLAYING MEDICAL IMAGES

(71) Applicant: Agfa HealthCare NV, Mortsel (BE)

(72) Inventor: Roel ADRIAENSENS, Mortsel (BE)

(73) Assignee: Agfa HealthCare NV, Mortsel (BE)

(21) Appl. No.: 15/551,650

(22) PCT Filed: Mar. 4, 2016
(86) PCT No.: PCT/EP2016/054670

§ 371 Date: Aug. 17, 2017

(30) Foreign Application Priority Data
Mar. 10, 2015 (EP) 15158330.9

(51) Int. Cl. G06F 19/00

(52) U.S. Cl. CPC G06F 19/321

(57) ABSTRACT

A data processing system for determining an availability speed of a medical image includes a client sends a request for viewing the medical image, a server that provides the client with the medical image upon reception of the request, an availability determining unit configured to: determine a download path to be followed by the medical image within the data processing system in order to be made available to the client, retrieve configuration parameters indicative for a transfer speed along the download path, and determine the availability speed of the medical image from the download path and from the configuration parameters.

### CROSS REFERENCE TO RELATED APPLICATIONS

This application is a 371 National Stage Application of PCT/EP2016/054670, filed Mar. 4, 2016. This application claims the benefit of European Application No. 15158330.9, filed Mar. 10, 2015, which is incorporated by reference herein in its entirety.

### BACKGROUND OF THE INVENTION

1. Field of the Invention

The present invention generally relates to the display of images for clinical applications, and in particular to managing the display of medical images in a medical imaging environment.

2. Description of the Related Art

Management of medical images from medical studies is important in medical applications such as for instance radiology, where several medical images of a patient may be acquired for example under different viewing angles and/or with different acquisition techniques such as an x-ray scan, a CT scan, an MRI scan, and ultrasound scan, etc. Data processing systems in medical imaging environment often comprise multiple remote client terminals who are connected towards a local proxy or a remote hub server. A remote client sends a request to view medical images. The medical images are stored in a picture archiving and communication system, also referred to as PACS, that provides economical storage of and convenient access to medical images acquired from multiple source machines and that is accessible from a server which can be for example a server cluster. In case of a distributed setup, also referred to as a hosted setup, the medical images may also be stored in in a cache of a local proxy server to facilitate faster image retrieval. A proxy server is installed in the local hospital of the remote client and is itself connected towards the server. Upon reception of the request from the remote client by the proxy server, the server renders the corresponding medical images to the corresponding remote client for display. The network bandwidth/connection speed between a remote client, the proxy server and the server may be different. For example, the network connection between a remote client and a proxy server is by default considered fast, for example when relying on a local LAN, while the bandwidth between the client and the hub server by default is considered slow, for example when relying on a WAN connection. Also, several types of caches may be implemented on a server, for example online memory caches, nearline caches, archives such as fast NAS, slow NAS, CD robot storage, etc. Depending on the nature of the cache, the access speed of a medical image can be considered faster or slower. The remote client is not aware where the requested medical images are stored and is not aware of the connection speeds within the data processing system nor of the access speed of the image storage. The remote client is therefore not aware when the requested medical images are going to be displayed at the side of the remote client. Displaying a medical image might then require much more time than acceptable by the remote client, for example several tens of seconds, or several minutes, etc. This time delay results in a delayed analysis of the medical image and therefore in a delayed diagnosis for the patient. Additionally if the medical image turns out not to be relevant for the diagnosis, the remote client wasted precious time for the health of the patient. This lack of flexibility also leads to a waste of processing power for the data processing system as all the requested medical images are retrieved and displayed at the side of the remote client.

### SUMMARY OF THE INVENTION

It is an objective to disclose a system and the related method that overcome the above identified shortcomings of existing solutions. More particularly, it is an objective to disclose such a system and method for improving the experience of a user who requests medical images in a time-saving and processing power-saving manner. It is a further objective to disclose such a system and method that bring relevance and flexibility in handling medical images within a data processing system.

According to a first aspect of the present invention, the above defined objectives are realized by a data processing system for determining an availability speed of a medical image, the data processing system comprising:
at least one client adapted to send a request for the medical image for viewing the medical image;
at least one server adapted to provide at least one client with the medical image upon reception of the request; CHARACTERIZED IN THAT the data processing system further comprises an availability determining unit, configured to:
determine a download path to be followed by the medical image within the data processing system in order to be made available to at least one client;
retrieve configuration parameters indicative for a transfer speed along the download path; and
determine the availability speed of the medical image from the download path and from the configuration parameters.

In accordance with a preferred embodiment of the present invention, the availability determining unit is a part of the client, and/or of the server. A medical image may be retrieved from a stored location within the data processing system. Beforehand, a user of the client inputs and stores configuration parameters in the data processing system, wherein the configuration parameters contain information indicative for a transfer speed between the different storage locations of the data processing system and the client. For example, a medical image can be transferred from a server cache to a client along the following path: from the server cache to the server, from the server to a proxy server, and from the proxy server to the client. Alternatively, a medical image can for example be transferred from a proxy server cache to a client along the following path: from a proxy server cache to a proxy server, and from the proxy server to the client. Depending on the location on which the medical image is stored, the medical image follows a different download path within the data processing system before the medical image is made available at the side of the client. The path the medical image follows to be made available at the side of the client is referred to as a download path for the client of the data processing system. A transfer speed is an indication of the speed needed by the medical image to be transferred along the download path. This transfer speed depends on the storage location of the medical image, and/or on the different network connections speed and/or bandwidth between one location within the data processing system and another location within the data processing system, and/or on the access speed of the storage location, as for example accessing a cache is typically fast, but accessing an archive may be slower. A transfer speed is determined by configuration parameters inputted by the user of the client. For example, the transfer speed between a server and a proxy server may be configured as slow, and/or the transfer speed between a server cache and a server may be configured as fast or moderate depending on the processing capabilities of the server cache, and/or the transfer speed between a proxy server and a client may be configured as fast, etc. When the medical image can be made available at the side of the client through more than one download paths, the availability determining unit determines the download path from the more than one download paths along which the transfer speed is the fastest.

According to a preferred embodiment of the present invention, an availability speed is determined from the combination of the download path and the corresponding configuration parameters inputted for the download path. The availability speed therefore contains information indicative for the time needed by the requested medical image to be made available at the side of the client. In accordance with a preferred embodiment of the present invention, a user at the side of the client is provided with a clear indication of the availability speed of the medical image the user generated a request for, and therefore of the expected download speed of the medical image. In other words, the user becomes aware of how long he or she must wait before the requested medical image is displayed at the side of the client. This drastically improves the experience of a user at the side of the client. For example, a notification at the side of the client may display the availability speed of the medical image. When the time delay between the generation of a request for a medical image and the display of the requested medical image at the side of the client is not acceptable for the user who requested the medical image, the user can overrule the request for the medical image. As a consequence, the medical image corresponding to the request is not displayed, which saves time to the user and also saves processing power to the data processing system. Additionally, when a user consecutively requests several medical images from a similar storage location, a user can generate tasks for the availability determining unit so that the data processing system pushes medical images that were stored at this location closer to the side of the client. This added flexibility drastically improves the availability speed, and this therefore improves the experience of the user. Additionally, when the availability speed of the medical image is not acceptable for a client, the client may overrule the request for the corresponding medical image. In this case, the client does not attempt to load the requested medical image, and the order overruling the request triggers notification events that trigger the data processing system to move the requested medical image within the data processing system in order to modify a storage location of the corresponding medical image, for example to make the requested medical image available at the side of the client. In other words, the order overruling the request that was sent by the client for the corresponding requested medical image automatically triggers the data processing system to move the requested medical image from a cache such as an archive or a server cache or a proxy server cache to another cache, which can for example be physically located closer to the side of the client. For example, the order automatically triggers the data processing system, and for example particularly the server corresponding to the server cache, to move the requested medical image from a server cache to a cache at the side of the corresponding client. When the storage location of the requested medical image changes, the availability speed of the requested medical image may be modified. When the requested medical image is only one hop away from the client, i.e. when the medical image has arrived on the cache of the client, the corresponding client may be notified by the data processing system that the availability speed of the requested medical image is modified and/or that the medical image is only one hop away from the client. This improves the flexibility of the data processing system as well as the experience of a user of a client as the user can chose when to retrieve requested medical images.

According to an alternative embodiment, the download path comprises a plurality of connection lines.

A download path for a medical image may consist of a plurality of connection lines. A connection line is the shortest link within the data processing system separating one entity of the data processing system from another entity of the data processing system. For example, a medical image is stored in a server cache and is requested at the side of the client. The download path for the medical image may then consist of three connection lines: a first connection line between a server cache and a server, a second connection line between the server and a proxy server, and a third connection line between the proxy server and the client. According to a preferred embodiment of the present invention, to each connection line is associated a transfer speed. In other words, a transfer speed is indicative for how fast a medical image is transferred along the corresponding connection line. According to a preferred embodiment of the present invention, the transfer speeds along the different connection lines of the download path may be categorized in different ranges, for example fast or moderate or slow. Alternatively, the transfer speeds along two or more connection lines of the download path may be categorized in the same range. According to a preferred embodiment of the present invention, the availability speed of a medical image is indicative for how fast the medical image is made available at the side of the client. The availability speed of a medical image may be categorized in different ranges, for example fast or moderate or slow. In other words, the availability speed of a medical image is indicative for how fast the medical image is transferred over one or more connection lines. In other words, when a medical image is transferred on one connection line, the transfer speed is equal to the availability speed, and when a medical image is transferred on more than one connection lines, the availability speed is indicative for how fast the medical image is made available at the side of the client, i.e. how fast the medical image is transferred over the one or more connection lines. The availability speed of a medical image is therefore limited by one or more connection lines of the download path within the data processing system on which the transfer speeds are the slowest. Additionally, when the medical image is stored on a server to which the client is not connected, the availability determining unit determines a download path for this medical image to make it available at the side of the client which consists of the following connection lines: the medical image may be transferred from the server on which it is stored to another server, for example to a hub, then from the other server to yet another server to which the client is connected and subsequently from the server to which the client is connected to the client.

According to an alternative embodiment, the availability determining unit is further adapted to generate an availability message from the availability speed and to display the availability message to at least one client.

The availability message comprises information indicative for the availability speed of a medical image. The availability determining unit is adapted to display the availability message at the side of the client. For example, a notification at the side of the client such as a pop-up window or any other suitable display at the side of the client may display the availability speed of the medical image. When the time delay between the generation of a request for a medical image and the display of the requested medical image at the side of the client is not acceptable for the user who requested the medical image, the user can overrule the request for the medical image. As a consequence, the medical image corresponding to the request is not displayed, which saves time to the user and also saves processing power to the data processing system.

According to an alternative embodiment, the availability determining unit is further adapted to assign to the availability message a logic availability value equal to:
fast, when the transfer speed along all of the connection lines is fast;
moderate, when the transfer speed along one of the connection lines is moderate;
slow, when the transfer speed along more than one of the connection lines is moderate; and
slow, when the transfer speed along at least one of the connection lines is slow.

This way, the availability speed of a medical image is limited by one or more connection lines of the download path within the data processing system on which the transfer speeds of the requested medical image are the slowest. The transfer speed along a connection line is considered as fast when the network bandwidth of all connection lines is large, i.e. equal to or higher than for example 100 Mbps, and/or images are available on a fast accessible network-attached storage, also referred to as NAS. The transfer speed along a connection line is considered as moderate when for example an image is located on a slower nearline storage. The transfer speed along a connection line is considered as slow when the network bandwidth is limited, i.e. equal to or smaller than for example 10 Mbps.

According to an alternative embodiment:
at least one client further comprises an order generating module, adapted to generate an order overruling the request and further adapted to send the order to the availability determining unit; and
the availability determining unit further comprises an order receiving module, adapted to receive and interpret the order from at least one client.

Upon reception of an availability message containing information indicative for the availability speed of a medical image, a user of the client judges the availability speed as unacceptable, for example when the logic availability value of the availability message is equal to slow. In this case, the user may overrule the request for the corresponding medical image. In other words, a user can decide not to receive the medical image he or she originally requested anymore when the logic availability value is equal to slow. This saves time to the user and also saves processing power to the data processing system. Alternatively, a user can decide to display the images even if the logic availability value for at least one medical image is equal to slow by explicitly requesting the retrieval of the corresponding at least one medical image.

According to an alternative embodiment, the data processing system is further adapted to:
upon reception of the order overruling the request, modify a storage location of the medical image corresponding to the request.

This way, when the availability speed of the medical image is not acceptable for a client, the client may overrule the request for the corresponding medical image. In this case, the client does not attempt to load the requested medical image, and the order overruling the request triggers notification events that trigger the data processing system to move the requested medical image within the data processing system in order to modify a storage location of the corresponding medical image, for example to make the requested medical image available at the side of the client. In other words, the order overruling the request that was sent by the client for the corresponding requested medical image automatically triggers the data processing system to move the requested medical image from a cache such as an archive or a server cache or a proxy server cache to another cache, which can for example be physically located closer to the side of the client. For example, the order automatically triggers the data processing system, and for example particularly the server corresponding to the server cache, to move the requested medical image from a server cache to a cache at the side of the corresponding client. When the storage location of the requested medical image changes, the availability speed of the requested medical image may be modified. When the requested medical image is only one hop away from the client, i.e. when the medical image has arrived on the cache at the side of the client, the corresponding client may be notified by the data processing system that the availability speed of the requested medical image is modified and/or that the medical image is only one hop away from the client and may be retrieved. This improves the flexibility of the data processing system as well as the experience of a user of a client as the user can chose when to retrieve requested medical images.

According to an alternative embodiment, the data processing system further comprises at least one proxy server adapted to receive the request from at least one client and to route the request to at least one server.

A proxy server receives one or more requests for medical images from one or more client terminals and routes the one or more requests to one or more servers. In other words, the proxy server balances the requests of the client terminals between the one or more servers. A proxy server can then for example be configured to route requests as a priority to one or more servers for which the resulting availability speed for the corresponding medical image will be the fastest. This way, the availability speed of the medical image is optimized.

According to an alternative embodiment, at least one proxy server comprises a proxy server cache.

This way, one or more medical images may be stored on one or more proxy server caches. Medical images stored on a proxy server cache are physically close to the client, and may therefore be associated with the fastest availability speed. Storing one or more medical images in the proxy server cache therefore aims at improving the availability speed of the corresponding medical images.

According to an alternative embodiment, at least one server comprises a server cache.

This way, one or more medical images may be stored on a server cache. The transfer speed between the server cache and the server may vary depending on the server cache. A server cache may be a database such as a PACS of a medical imaging environment. This way, medical images are not stored on the servers, which saves processing power to the data processing system, and reduces the power costs associated with its implementation and its use. Alternatively, a server cache may be any other suitable database suitable for storage of medical images in a medical imaging environment.

According to an alternative embodiment, the medical image is retrieved from the proxy server cache or from the server cache.

Depending on whether a medical image is retrieved from a proxy server cache or from a server cache, the availability speed of the medical image varies. A medical image is stored in a single storage location. A single medical image may be stored in the proxy server cache, or in the server cache. According to a preferred embodiment of the present invention, a user of the client may request for example a plurality of medical images linked to one medical study. A medical study is understood as defined by the standard Digital Imaging and Communications in Medicine, also referred to as DICOM. DICOM is a standard for handling, storing, printing, and transmitting information in medical imaging. A DICOM data object consists of a number of attributes, including items such as name, ID of the patient, etc. A medical study as defined by the DICOM standard may then comprise one medical image or a plurality of medical images. The medical images of one medical study may be stored at different locations within the data processing system. According to a preferred embodiment of the present invention, the availability speed of the medical study is then determined by the availability speed of one or more medical images of the corresponding medical study for which the logic availability value is the slowest, i.e. by the availability speeds of one or more medical images that are the slowest to be made available at the side of the client.

According to an alternative embodiment, the availability determining unit further comprises a configuration receiving unit, adapted to receive the configuration parameters from at least one client.

This way, a user of the client can manually input configuration parameters taken into account in the determination of the availability speed of a medical image. Indeed, a user may statically configure the transfer speed of one or more connection lines comprised in the download path of the requested medical image. In other words, a user may configure the transfer speed of a medical image along each of the connection lines of the download path. Alternatively, the transfer speed on a connection line is determined by for example dynamically monitoring the bandwidth along the download path, and/or monitoring how busy the communication along the download path is, e.g. how many medical images are being transferred along the same download path, etc. This dynamic monitoring can be performed periodically, and/or can be performed every time the data processing system receives a request for a medical image. This way, the availability speed of a medical image is more accurately determined and the overall experience of a user of the client is improved.

According to an alternative embodiment:
at least one client further comprises a task generator adapted to generate tasks and to send the tasks to the availability determining unit;
the availability determining unit further comprises a task receiving unit adapted to receive the tasks from at least one client;
the availability determining unit is further adapted to forward the tasks to at least one proxy server and at least one server; and
at least one proxy server and at least one server are further adapted to execute the tasks.

For example, when a user consecutively requests several medical images from a similar storage location, a user can generate tasks for the availability determining unit so that the data processing system pushes medical images that were stored at this location closer to the client. This added flexibility drastically improves the availability speed, and this therefore improves the experience of the user.

According to an alternative embodiment, at least one server forwards the medical image from the server cache to the proxy server cache.

A medical image may be pushed from the server cache to the proxy server cache in order to improve its availability speed. For example, when the availability speed of the medical image is not acceptable for a client, the client may overrule the request for the corresponding medical image. In this case, the client does not attempt to retrieve the requested medical image, and the order overruling the request triggers notification events that trigger the data processing system to move the requested medical image within the data processing system in order to modify a storage location of the corresponding medical image, for example to make the requested medical image available at the side of the client. In other words, the order overruling the request that was sent by the client for the corresponding requested medical image automatically triggers the data processing system to move the requested medical image from a cache such as an archive or a server cache or a proxy server cache to another cache, which can for example be physically located closer to the side of the client. For example, the order automatically triggers the data processing system, and for example particularly the server corresponding to the server cache, to move the requested medical image from the server cache to a cache at the side of the corresponding client. When the storage location of the requested medical image changes, the availability speed of the requested medical image may be modified. When the requested medical image is only one hop away from the client, i.e. when the medical image has arrived on the cache of the client, the corresponding client may be notified by the data processing system that the availability speed of the requested medical image is modified and/or that the medical image is only one hop away from the client and may be retrieved. This improves the flexibility of the data processing system as well as the experience of a user of a client as the user can chose when to retrieve requested medical images.

According to a second aspect of the present invention, there is provided a computer-implemented method for determining an availability speed of a medical image, the method comprising the steps of:
receiving a request for the medical image from at least one client;
routing the request for the medical image to at least one server;
determining a download path to be followed by the medical image in order to be made available to at least one client;
retrieving configuration parameters indicative for a transfer speed along the download path; and
determining the availability speed of the medical image from the download path and from the configuration parameters.

In accordance with a preferred embodiment of the present invention, a medical image may be retrieved from a stored location. Beforehand, a user of a client inputs and stores configuration parameters, wherein the configuration parameters contain information indicative for a transfer speed between different storage locations and the client. For example, a medical image can be transferred from a server cache to a client along the following path: from the server cache to the server, from the server to a proxy server, and from the proxy server to the client. Alternatively, a medical image can for example be transferred from a proxy server cache to a client along the following path: from a proxy server cache to a proxy server, and from the proxy server to the client. Depending on the location on which the medical image is stored, the medical image follows a different download path before the medical image is made available at the side of the client. The path the medical image follows to be made available at the side of the client is referred to as a download path for the client. A transfer speed is an indication of the speed needed by a medical image to be transferred along a download path. This transfer speed depends on the storage location of the medical image, and/or on the different network connections speed and/or bandwidth between one location within the data processing system and another location within the data processing system, and/or on the access speed of the storage location, as for example accessing a cache is typically fast, but accessing an archive may be slower. A transfer speed is determined by the configuration parameters inputted by the user of the client. In other words, a user may configure the transfer speed of a medical image along each of the connection lines of the download path. For example, the transfer speed between a server and a proxy server may be configured as slow, and/or the transfer speed between a server cache and a server may be configured as fast or moderate depending on the processing capabilities of the server cache, and/or the transfer speed between a proxy server and a client may be configured as fast, etc. Alternatively, the transfer speed depends for example on a dynamic monitoring of the bandwidth along the download path, and/or on how busy the communication along the download path is, e.g. how many medical images are being transferred along the same download path, etc. This dynamic monitoring can be performed periodically, and/or can be performed every time the server receives a request for a medical image. When the medical image can be made available at the side of the client through more than one download paths, the availability determining unit determines the download path from the more than one download paths along which the transfer speed is the fastest.

According to a preferred embodiment of the present invention, an availability speed is determined from the combination of the download path and the corresponding configuration parameters inputted for the download path. The availability speed therefore contains information indicative for the time needed by a requested medical image to be made available at the side of the client. In accordance with a preferred embodiment of the present invention, a user at the side of the client is provided with a clear indication of the availability speed of the medical image the user generated a request for, and therefore of the expected download speed of the medical image. In other words, the user becomes aware of how long he or she must wait before the requested medical image is displayed at the side of the client. This drastically improves the experience of a user at the side of the client. For example, a notification at the side of the client may display the availability speed of the medical image. When the time delay between the generation of a request for a medical image and the display of the requested medical image at the side of the client is not acceptable for the user who requested the medical image, the user can overrule the request for the medical image. As a consequence, the medical image corresponding to the request is not displayed, which saves time to the user and also saves processing power. Additionally, when a user consecutively requests several medical images from a similar storage location, a user can generate tasks so that medical images that were stored at this location are pushed closer to the side of the client. This added flexibility drastically improves the availability speed, and this therefore improves the experience of the user. Additionally, when the availability speed of the medical image is not acceptable for a client, the client may overrule the request for the corresponding medical image. In this case, the client does not attempt to load the requested medical image, and the order overruling the request triggers notification events that trigger the data processing system to move the requested medical image within the data processing system in order to modify a storage location of the corresponding medical image, for example to make the requested medical image available at the side of the client. In other words, the order overruling the request that was sent by the client for the corresponding requested medical image automatically triggers the data processing system to move the requested medical image from a cache such as an archive or a server cache or a proxy server cache to another cache, which can for example be physically located closer to the side of the client. For example, the order automatically triggers the data processing system, and for example particularly the server corresponding to the server cache, to move the requested medical image from a server cache to a cache at the side of the corresponding client. When the storage location of the requested medical image changes, the availability speed of the requested medical image may be modified. When the requested medical image is only one hop away from the client, i.e. when the medical image has arrived on the cache of the client, the corresponding client may be notified by the data processing system that the availability speed of the requested medical image is modified and/or that the medical image is only one hop away from the client and may be retrieved. This improves the flexibility of the data processing system as well as the experience of a user of a client as the user can chose when to retrieve requested medical images.

The current invention in addition also relates to a computer program comprising software code adapted to perform the method according to a preferred embodiment of the present invention.

The invention further relates to a computer readable storage medium comprising the computer program according to a preferred embodiment of the present invention.

### BRIEF DESCRIPTION OF THE DRAWINGS

FIG. 1 schematically illustrates an embodiment of a data processing system for determining an availability speed of a medical image.

FIG. 2 schematically illustrates a suitable computing system for hosting the data processing system of FIG. 1.

### DETAILED DESCRIPTION OF THE PREFERRED EMBODIMENTS

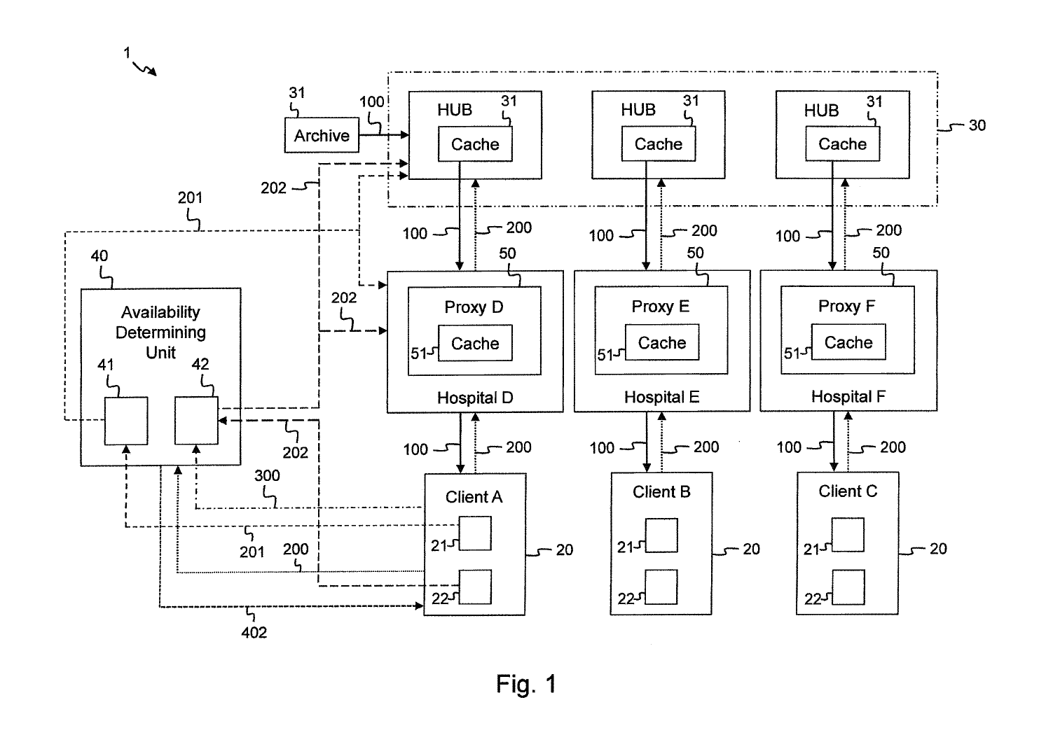

According to an embodiment shown in FIG. 1, the data processing system 1 according to a preferred embodiment of the present invention comprises three client terminals 20, three proxy servers 50, three servers 30 and an availability determining unit 40. According to an alternative embodiment, the data processing system 1 comprises one or more client terminals 20, and/or one or more proxy servers 50 and/or one or more servers 30. The three client terminals 20 in FIG. 1 are labelled client A, client B and client C. Each client is adapted to generate and send a request 200 for a medical image 100 for viewing the corresponding medical image 100. Each client is adapted to send one or more requests 200 for one or more medical images 100 to proxy servers 50. As visible in FIG. 1, the data processing system 1 comprises three proxy servers 50 labelled proxy server D, proxy server E and proxy server F. The proxy servers 50 receive one or more requests 200 for respective medical images 100 from one or more of the client terminals 20 of the data processing system 1. As visible in FIG. 1, the proxy server 50 labelled D receives requests 200 from the client 20 labelled A, the proxy server 50 labelled E receives requests 200 from the client 20 labelled B and the proxy server 50 labelled F receives requests 200 from the client 20 labelled C. Alternatively, one proxy server 50 can receive one or more requests 200 from one or more client terminals 20. The proxy servers 50 are adapted to route the one or more requests 200 from the one or more client terminals 20 to one or more servers 30. As visible in FIG. 1, the three servers 30 are adapted to retrieve the one or more medical images 100 corresponding to the one or more requests 200 received from the one or more client terminals 20 from a storage. For example, as visible on FIG. 1, the storage can be an archive such as a cache 31. Any other suitable storage may be used to store medical images 100 that the servers 30 can retrieve upon reception of a corresponding request 200 from a client 20. The retrieved medical images 100 corresponding to the request 200 are then sent to the respectively corresponding client 20 for viewing. The data processing system 1 according to a preferred embodiment of the present invention further comprises an availability determining unit 40. The availability determining unit 40 is adapted to receive the request 200 generated by one or more client terminals 20. For example, in FIG. 1, the availability determining unit 40 receives the request 200 from the client 20 labelled A. Upon reception of the request 200, the availability determining unit 40 is adapted to determine a download path to be followed by the medical image 100 within the data processing system 1 so that the medical image 100 is made available at the side of the client 20. A download path within the data processing unit 1 comprises a plurality of connection lines. For example in FIG. 1, the connection between the client 20 labelled A and the proxy server 50 labelled D is a connection line. Also, for example, the connection between the proxy server 50 labelled E and the server 30 is another connection line. The availability determining unit 40 is further adapted to retrieve configuration parameters indicative for a transfer speed along the download path. The availability determining unit 40 is further adapted to use the download path and the configuration parameters to determine the availability speed of the medical 100 corresponding to the request 200 of the client 20. The availability determining unit 40 is further adapted to generate an availability message 402 from the availability speed and to send the availability message 402 to the client 20 labelled A for viewing the availability message 402. The availability message 402 comprises a logic availability value equal to fast, moderate or slow. This provides the client 20 labelled A with an estimation of how long the client 20 labelled A must wait before the medical image 100 corresponding to the request 200 is displayed at the side of the client 20 labelled A. The availability determining unit 40 is an entity of the data processing system 1. Alternatively, a client 20 comprises the availability determining unit 40. According to an alternative embodiment, a server 30 comprises the availability determining unit 40. According to a further alternative embodiment, a proxy server 50 comprises the availability determining unit 40.

In FIG. 1, each client 20 optionally comprises an order generating module 21 adapted to generate an order 201. The order 201 may for example overrule the request 200 generated by the corresponding client 20. Each client 20 is adapted to send the order 201 to the availability determining unit 40. The availability determining unit 40 optionally further comprises an order receiving module 41 adapted to receive and interpret the order 201 from a client 20. The order receiving module 41 is adapted to send the order 201 to one or more servers 30 and/or to one or more proxy servers 50. For example in FIG. 1, the availability determining unit 40 sends the order 201 to the proxy server 50 labelled D and to the server. Upon reception of an order 201, a proxy server 50 and/or a server 30 are adapted to interpret the order 201 and to not execute the corresponding request 200 the proxy server 50 and/or the server 30 received from a client 20. The request 200 is overruled and the respective corresponding medical image 100 is not made available at the side of the client 20. Additionally, when the requested medical image 100 is moved from a server cache 31 or a proxy server cache 51 to a cache at the side of the client 20 who requested the corresponding medical image 100, a notification is displayed at the side of the corresponding client 20 to indicate that the requested medical image 100 may be retrieved by the client 20. When the availability speed of the medical image 100 is not acceptable for a client 20, the client 20 may overrule the request 200 for the corresponding medical image 100. In this case, the client 20 does not attempt to load the requested medical image 100, and the order 201 overruling the request 200 triggers notification events that trigger the data processing system 1 to move the requested medical image 100 within the data processing system 1 in order to modify a storage location of the corresponding medical image 100, for example to make the requested medical image 100 available at the side of the client 20. In other words, the order 201 overruling the request 200 that was sent by the client 20 for the corresponding requested medical image 100 automatically triggers the data processing system 1 to move the requested medical image 100 from a cache such as an archive or a server cache 31 or a proxy server cache 51 to another cache, which can for example be physically located closer to the side of the client 20. For example, the order 201 automatically triggers the data processing system 1, and for example particularly the server 30 corresponding to the server cache 31, to move the requested medical image 100 from a server cache 31 to a cache at the side of the corresponding client 20. When the storage location of the requested medical image 100 changes, the availability speed of the requested medical image 100 may be modified. When the requested medical image 100 is only one hop away from the client 20, i.e. when the medical image 100 has arrived on the cache of the client 20, the corresponding client 20 may be notified by the data processing system 1 that the availability speed of the requested medical image 100 is modified and/or that the medical image 100 is only one hop away from the client 20 and may be retrieved. This improves the flexibility of the data processing system 1 as well as the experience of a user of a client 20 as the user can chose when to retrieve requested medical images 100.

In FIG. 1, each client 20 optionally comprises a task generator 22. Each task generator is adapted to generate tasks 202 and each client 20 is adapted to send the tasks 202 to the availability determining unit 40. The availability determining unit 40 further optionally comprises a task receiving unit 42 adapted to receive the tasks 202 from one or more client terminals 20. For example in FIG. 1, the configuration receiving unit 42 receives tasks from the client 20 labelled A. The configuration receiving unit 42 of the availability determining unit 40 is further adapted to forward the tasks 202 to the proxy servers 50 and/or to the servers 30, which are further adapted to interpret the tasks 202 and execute the tasks 202.

In FIG. 1, each proxy server 50 optionally comprises a cache 51. The three caches 51 of the data processing system 1 are adapted to store medical images 100. In FIG. 1, each server 30 optionally comprises a cache 31. The caches 31 are adapted to store medical images 100.

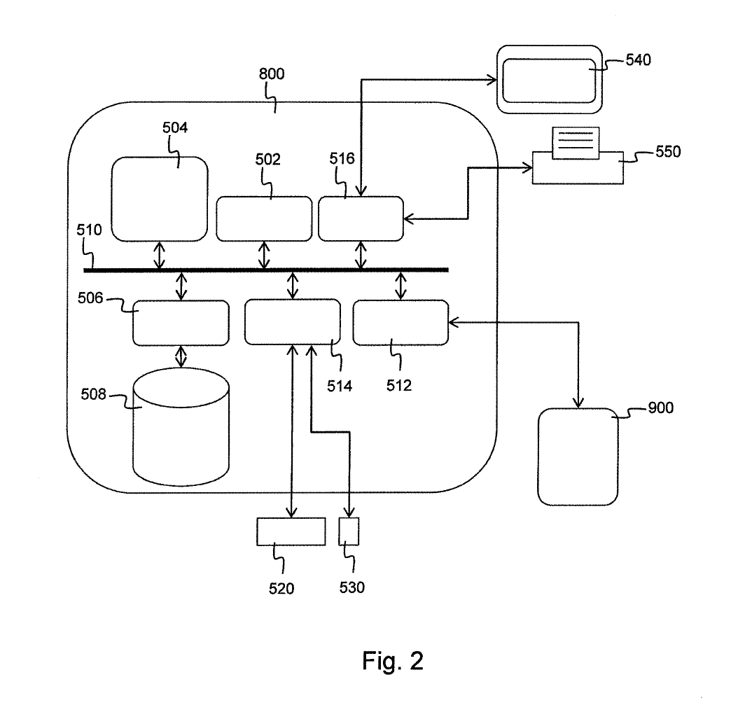

FIG. 2 shows a suitable computing system 800 for hosting the data processing system 1 of FIG. 1. Computing system 800 may in general be formed as a suitable general purpose computer and comprise a bus 510, a processor 502, a local memory 504, one or more optional input interfaces 514, one or more optional output interfaces 516 a communication interface 512, a storage element interface 506 and one or more storage elements 508. Bus 510 may comprise one or more conductors that permit communication among the components of the computing system. Processor 502 may include any type of conventional processor or microprocessor that interprets and executes programming instructions. Local memory 504 may include a random access memory (RAM) or another type of dynamic storage device that stores information and instructions for execution by processor 502 and/or a read only memory (ROM) or another type of static storage device that stores static information and instructions for use by processor 504. Input interface 514 may comprise one or more conventional mechanisms that permit an operator to input information to the computing device 800, such as a keyboard 520, a mouse 530, a pen, voice recognition and/or biometric mechanisms, etc. Output interface 516 may comprise one or more conventional mechanisms that output information to the operator, such as a display 540, a printer 550, a speaker, etc. Communication interface 512 may comprise any transceiver-like mechanism such as for example two 1 Gb Ethernet interfaces that enables computing system 800 to communicate with other devices and/or systems, for example mechanisms for communicating with one or more other computing systems 900. The communication interface 512 of computing system 800 may be connected to such another computing system by means of a local area network (LAN) or a wide area network (WAN, such as for example the internet, in which case the other computing system 580 may for example comprise a suitable web server. Storage element interface 506 may comprise a storage interface such as for example a Serial Advanced Technology Attachment (SATA) interface or a Small Computer System Interface (SCSI) for connecting bus 510 to one or more storage elements 508, such as one or more local disks, for example 1 TB SATA disk drives, and control the reading and writing of data to and/or from these storage elements 508. Although the storage elements 508 above is described as a local disk, in general any other suitable computer-readable media such as a removable magnetic disk, optical storage media such as a CD or DVD, -ROM disk, solid state drives, flash memory cards, . . . could be used.

The data processing system 1 of FIG. 1 can be implemented as programming instructions stored in local memory 504 of the computing system 800 for execution by its processor 502. Alternatively the data processing system 1 of FIG. 1 could be stored on the storage element 508 or be accessible from another computing system 900 through the communication interface 512.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third“, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to a preferred embodiment of the present invention in other sequences, or in orientations different from the one(s) described or illustrated above.

1-15. (canceled)

16. A data processing system for determining an availability speed of a medical image, the data processing system comprising:
at least one client terminal that sends a request for the medical image to view the medical image;
at least one server that provides the at least one client terminal with the medical image upon reception of the request; and
a processor configured or programmed to function as an availability determining processor to:
determine a download path to be followed by the medical image in order to be made available to the at least one client terminal;
retrieve configuration parameters indicative of a transfer speed along the download path; and
determine the availability speed of the medical image from the download path and from the configuration parameters.

17. The data processing system according to claim 16, wherein the download path includes a plurality of connection lines.

18. The data processing system according to claim 17, wherein the availability determining processor generates an availability message from the availability speed and displays the availability message to the at least one client terminal.

19. The data processing system according to claim 18, wherein the availability determining processor assigns to the availability message a logic availability value equal to:
fast, when the transfer speed along all of the plurality of connection lines is fast;
moderate, when the transfer speed along one of the plurality of connection lines is moderate;
slow, when the transfer speed along more than one of the plurality of connection lines is moderate; and
slow, when the transfer speed along at least one of the plurality of connection lines is slow.

20. The data processing system according to claim 16, wherein
the at least one client terminal further includes an order generator that generates an order overruling the request and sends the order to the availability determining processor; and
the availability determining processor further includes an order receiver that receives and interprets the order from the at least one client terminal.

21. The data processing system according claim 20, wherein the processor is configured or programmed to, upon reception of the order overruling the request, modify a storage location of the medical image corresponding to the request.

22. The data processing system according to claim 16, further comprising at least one proxy server that receives the request from the at least one client terminal and routes the request to the at least one server.

23. The data processing system according to claim 22, wherein the at least one proxy server includes a proxy server cache.

24. The data processing system according to claim 23, wherein the at least one server includes a server cache.

25. The data processing system according to claim 24, wherein the medical image is retrieved from the proxy server cache or from the server cache.

26. The data processing system according to claim 16, wherein the availability determining processor further includes a configuration receiver that receives the configuration parameters from the at least one client terminal.

27. The data processing system according to claim 24, wherein the at least one server forwards the medical image from the server cache to the proxy server cache.

28. The data processing system according claim 20, wherein the availability determining processor is included in the at least one client terminal.

29. The data processing system according claim 20, wherein the availability determining processor is included in the at least one server.

30. A computer-implemented method for determining an availability speed of a medical image, the method comprising the steps of:
receiving a request for the medical image from at least one client terminal;
routing the request for the medical image to at least one server;
determining a download path to be followed by the medical image in order to be made available to the at least one client terminal;
retrieving configuration parameters indicative of a transfer speed along the download path; and
determining the availability speed of the medical image from the download path and from the configuration parameters.

31. A non-transitory computer readable storage medium comprising computer-executable instructions which, when executed by a computing system, performs the method according to claim 30.
